(19) United States
(12) Patent Application Publication
(10) Pub. No.: US 2017/0018115 A1
(43) Pub. Date: Jan. 19, 2017

(54) VISUALISATION OF WORK STATUS FOR A MINE WORKSITE

(71) Applicant: Caterpillar of Australia Pty, Tullamarine, Victoria (AU)

(72) Inventors: Glen Peter Blanchard, Upper Coomera (AU); Brett Eisenmenger, Everton Hills (AU); Ramkumar Nagabhshanam, Deception (AU)

(73) Assignee: Caterpillar of Australia Pty, Tullamarine, Victoria (AU)

(21) Appl. No.: 15/123,964

(22) PCT Filed: Mar. 19, 2015
(86) PCT No.: PCT/AU2015/050118

§ 371 Date: Sep. 6, 2016

(30) Foreign Application Priority Data
Mar. 19, 2014 (AU) 2014900965
May 30, 2014 (AU) 2014202958

(51) Int. Cl. G06T 17/05; E21D 9/14; E21C 35/00; G06T 15/08; G01C 5/00

(52) U.S. Cl. CPC G06T 17/05; G06T 15/08; G01C 5/00; E21C 35/00; E21D 9/14; G06T 2215/16

(57) ABSTRACT

Described herein is a computer-implemented method for illustrating work status for an area of interest of a mine worksite. The method comprises determining a dataset comprising recorded data representing an elevation map of a surface of the mine worksite for at least the area of interest. The elevation map is based on measured data for the surface. The data set also comprises reference data representing a reference elevation topography for at least the area of interest. The method further comprises generating model data, based on the determined dataset, defining a 3-dimensional model for illustrating, in an image portraying a 3-dimensional view of the model, divergence between the elevation map and the reference elevation topography.

### FIELD OF THE INVENTION

The present disclosure relates to methods and systems for determining work status in a mine worksite, which in one embodiment involves assessing work status in construction and/or excavation work for developing infrastructure such as roads.

### BACKGROUND OF THE INVENTION

In the mining industry, mine operators need to prepare infrastructure for vehicle and equipment access, and for transporting ore and other materials. Such infrastructure includes roads, drill holes, and other features created by manipulating of the topography of the worksite. The creation of such infrastructure involves designing an intended topography for the worksite and manipulating the worksite, by cutting away parts of the worksite that are above an intended elevation (above grade) and by filling areas of the worksite below an intended elevation (below grade) in order to meet the specification tolerances of the design. However, it can be difficult to assess the status of work that has been done or that needs to be done in fulfilling this objective. Therefore, there is a need to provide a tool for assisting assessment of the work status.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect of the present disclosure, there is described a computer-implemented method for illustrating work status for an area of interest of a mine worksite. The method comprises determining a dataset comprising recorded data representing an elevation map of a surface of the mine worksite for at least the area of interest. The elevation map is based on measured data for the surface. The data set also comprises reference data representing a reference elevation topography for at least the area of interest. The method further comprises generating model data, based on the determined dataset, defining a 3-dimensional model for illustrating, in an image portraying a 3-dimensional view of the model, divergence between the elevation map and the reference elevation topography

In another aspect of the present disclosure, there is described a computing system for illustrating work status for an area of interest of a mine worksite. The computing system comprises a memory system for storing computer executable instructions, and a processing system. The processing system is configured to read the computer executable instructions from the memory system. Upon executing the computer executable instructions, the processing system is configured to determine a dataset. The dataset comprises recorded data representing an elevation map of a surface of the mine worksite for at least the area of interest, the elevation map being based on measured data for the surface. The dataset also comprises reference data representing a reference elevation topography for at least the area of interest. The processing system is also configured to generate model data, based on the determined dataset, defining a 3-dimensional model for illustrating, in an image portraying a 3-dimensional view of the model, divergence between the elevation map and the reference elevation topography.

In another aspect of the present disclosure, there is described a further computer-implemented method for illustrating work status for an area of interest of a mine worksite. The method comprises determining a dataset. The dataset comprises recorded data representing an elevation map of a surface of the mine worksite for at least the area of interest, the elevation map being based on measured data for the surface. The dataset also comprises reference data representing a reference elevation topography for at least the area of interest. The method further comprises generating model data, based on the determined dataset, defining a 3-dimensional model for illustrating, in an image portraying a 3-dimensional view of the model, divergence between the elevation map and the reference elevation topography. The reference elevation topography is a designed elevation topography that is intended for at least the area of interest and wherein the image displays both the elevation map and the reference elevation topography.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a flow chart of a computer-implemented method for illustrating work status for an area of interest in a mine worksite, in accordance with the present disclosure;

FIG. 2 illustrates a conceptual diagram of a system for performing the computer-implemented method of FIG. 1;

FIG. 3 illustrates a user interface for a software program, the user interface illustrating a plan view of a worksite and an area of interest in the worksite for which an intended topography has been designed;

FIG. 4 illustrates a user interface illustrating a 2-dimensional, plan view of the area of interest shown in FIG. 3;

FIG. 5 illustrates an image according to an embodiment of the present disclosure, portraying a 3-dimensional view of the area of interest, illustrating divergence between an elevation map for the worksite and a reference elevation topography; and

FIG. 6 illustrates an image portraying another 3-dimensional view of the area of interest to illustrate the divergence in accordance with another embodiment of the present disclosure.

### DETAILED DESCRIPTION OF THE EMBODIMENTS

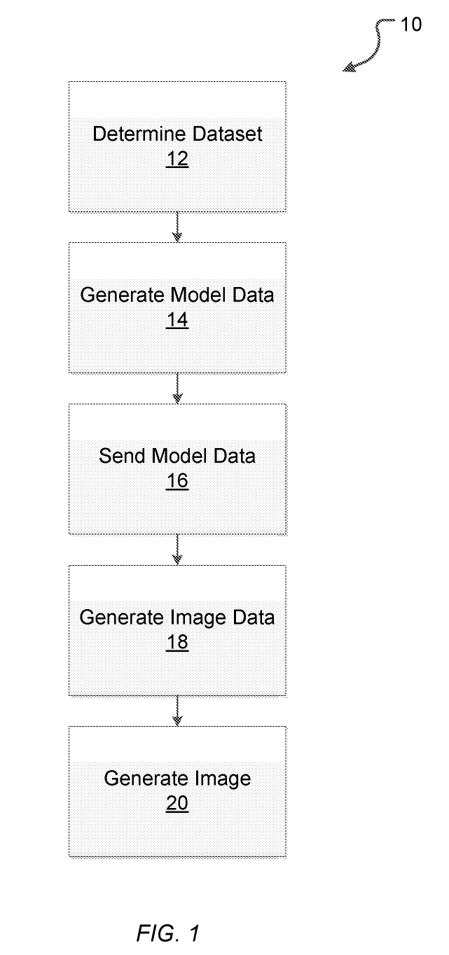

An exemplary process 10 for performing a computer-implemented method for illustrating work status for an area of interest in a mine worksite is illustrated in FIG. 1. Process 10 derives a 3-dimensional (3D) model for comparing differences between the input two elevation models for the area of interest.

A first of the elevation models is an elevation map of a surface of the mine worksite. The elevation map is comprised of recorded data that is based on measurements taken for the surface. Therefore the elevation map represents an actual elevation topography possessed by the worksite. The recorded data includes elevation values (eg, with respect to sea level a mine-specific reference location) for a grid of position coordinates. The position coordinates may, for example, represent longitude and latitude coordinates, or east/west and north/south distances from a mine-specific reference location. The elevation map is thus represented as a digital elevation model for an area of the mine worksite that includes at least the area of interest associated with a work task.

The second elevation model is a reference elevation topography for at least the area of interest to which the first elevation map is compared. In one embodiment, the reference elevation topography is a designed elevation topography that is intended for the area of interest. Such a designed elevation topography is generated by computer-aided design (CAD) software. In an alternative embodiment, however, the reference elevation topography may be a second elevation map for at least the area of interest. The second elevation map may be based on measurements of the area's topography taken at some time different to that of the first elevation map.

At a first step 12 in process 10, a dataset is determined to comprise the two input elevation models. For simplicity the two elevation models are hereinafter exemplified as a first elevation map based on measurements, and a reference elevation topography defined by design data, as discussed above. For reference elevation topography may, for example, represent an intended topography model for road for a dragline.

The elevation map is generally recorded in a raster format which defines a rectangular grid of matrix values, the grid location corresponding to a 2-dimensional location coordinate (eg. metres north and east compared with a reference location). The value stored at each grid location defines the elevation at the coordinate. The elevation value may be directly measured data or may be interpolated or transformed from other measured elevation data. The recorded elevation map may have an accuracy of 10 mm. The data for the elevation map may be collected by one or more vehicles that move along the surface of the worksite, logging their location coordinates and elevation derived from a positioning system on the vehicles.

The reference elevation topography is generally stored as a CAD file which defines a designed elevation topography using vectors. Such a vector-based representation may be a triangulated irregular network (TIN).

Once the dataset has been determined, model data defining a 3-dimensional model including at least a representation of the difference in elevation between the two input models is generated at step 14. The generated model is derived, at least in part, by subtracting the elevation of one of input models from the other. To prepare the data for subtraction, the reference elevation topography is converted to raster format to enable a matrix subtraction. In the subtraction process, each coordinate value in one matrix is subtracted from the value of the corresponding coordinate in the other matrix. For example, elevation values for the reference elevation topography may be subtracted from elevation values for the recorded elevation map that correspond to the same coordinates.

The result of the subtraction is 3-dimensions of spatial data, represented as raster matrix, and which may define a 3-model to be illustrated, or may define part of the illustrated model. This calculated raster matrix defines a 2 dimensional matrix or grid of coordinates covering the area of interest, with each coordinate having an associated third dimension value representing a vertical or elevation divergence between the two input models. Since the reference elevation topography was subtracted from the elevation map, positive values of the outputted raster matrix indicate that the surface of the mine has a higher altitude than the reference elevation topography, whereas negative values indicate that the surface of the mine has a lower altitude than the reference elevation topography. In one embodiment the outputted raster includes elevation data accurate to 10 mm, provided for location coordinate measurements that are spaced in 1 meter increments. The outputted raster is also referred to herein as a “difference raster” or “difference file”.

As has been discussed, a 3-dimensional model for illustrating divergence between the two input models is generated. This generated model is also referred to herein as an visualisation model. The visualisation model may be represented solely by the difference raster. In some embodiments, the visualisation model will also include further raster information, for example a reference raster (eg defining to the reference topography), so that the divergence may be illustrated in the context of the a reference surface. In addition or instead of the reference topography, the visualisation model may include the reference elevation topography raster. Thus, in addition to displaying information derived from the difference in calculation, the visualisation component can display the elevation map or the reference elevation topography, or both simultaneously.

The spatial coordinates defined the raster or rasters may be sufficient to determine the 3-dimensional visualization model, if downstream processing is configured to render a 3D image based only on these spatial coordinates. However, in some embodiments, the 3-dimensional visualisation model will also include further information defining how to render the 3-image from the spatial coordinates.

Once the 3-dimensional visualisation model has been generated, a 3-dimensional visualisation of the visualisation model is performed to enable a person to easily assess locations in the area of interest which are respectively above, below and on-grade with respect to the reference elevation topography. The visualisation also provides a visual indication of the volume of worksite material (ie, earth material) above the reference elevation topography (more specifically, the volume above grade) compared with the volume of worksite material below the reference elevation topography (more specifically, the volume below grade).

The visualisation model is sent to a visualisation system at step 16 to generate image data. The visualisation system generates an image portraying the 3D visualisation model for a selected viewing angle (above or below horizontal) and a selected orientation (by varying the longitude/latitude viewing position) with respect to the area of interest. The image is rendered to portray the 3-dimensional aspect of the visualisation model, resulting in the generation of image data at step 18. At step 20, the image data is sent to graphics hardware to process and display an image represented by the image data.

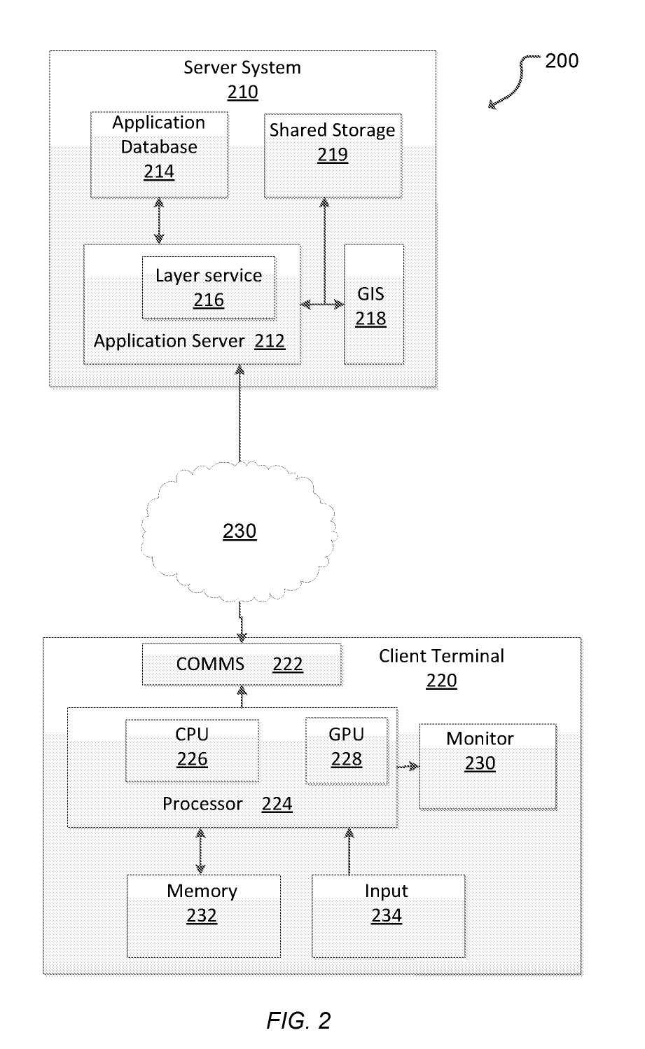

FIG. 2 shows a block diagram of an exemplary computing environment 200 that may be used to implement process 10. The computing environment includes a server system 210 in communication with a client terminal 220 via network 230; such as the internet. The server system 210 includes a processing system and memory system in the form of application server 212 which hosts a web application accessed by client terminal 220. The web application may for example be CAT® Minestar™ running a software component called “Terrain”, which is specifically designed for managing drilling, dragline, grading and loading operations. The web application utilises application database 214 which stores information for running the web application program. The application server includes a layer service 216 for managing files utilised by a geographic information system (GIS) which is operated via the application server 212. A shared storage database 219 is accessible by both the layer service 216 and the GIS 218, and stores topographic data and design files such as the two input elevation models and any other elevation models which may optionally be selected, read or updated. Thus, the storage database 219 may include a raster file defining the current elevation map of the worksite or a portion of the worksite, a vector file defining the intended design, and archived elevation maps representing measurement-based topography maps for the worksite at previous times.

The storage database 219 further stores the difference file in raster format, once it has been determined. The difference file is generated by the GIS, which calculates the difference file once a user selected the elevation models upon which a work status visualisation is to be based. The application database 214 and shared storage database server 219 may be stored on the memory system of the application server 212. In other embodiments, at least the shared storage database may reside in a separate storage server.

The files stored on the database 219 may be accessed by a client via client terminal 220 such as a personal computing device or laptop. In other embodiments, a tablet or smart phone may act as the client terminal. In the embodiment illustrated in

FIG. 2, client terminal 220 has a communications port 222 for communicating with application server 212, and a processor 224 comprising a central processing unit (CPU) 226 for operating a web browser to interface with application server 212. Client terminal 220 acts as a visualisation system for generating an image of the 3D visualisation model. In other embodiments, however, the visualisation system may performed by the same computer that generates the 3D visualisation model data. For example, in such embodiments, the client terminal 220 may include some or all of the components of server system 210, with the processing and memory functions of the application server being performed by processor 224 and memory 232 of the client terminal 220.

Client terminal 220 includes processor 224 also has a graphics processing unit (GPU) 228, integrated onto the CPU die or as an auxiliary processing circuit, for processing graphics information. The GPU 228 generates data to be displayed on a monitor 230 to provide a visual display of the web browser and the image of the 3D visualisation model in the browser. Memory 232 stores instructions that configure the central processing unit 226 to operate the web browser and plug-in software, such as Adobe Flash or Flex, to enable the browser to interpret graphics information sent from application server 212. The interpretation of the graphics is also enabled by a 3D framework in the form of an application-specific software plug-in stored in memory 232. Client terminal 220 also includes a user input 234 to enable a user to enter information on, and interact with, the web browser, allowing the user to select elevation model files for work status analysis and to select the projected view of the 3-D generated image of the visualisation model.

To operate process 10 in computing environment 200 a user uses client terminal 220 to access the web application on a website, hosted by application server 212. The user logs in to an account specific to that user, giving them access to recorded elevation map and design topography files, and any stored difference files that have already been generated. The user selects a recorded elevation map and a reference elevation topography to be compared in process 10. Application server 212 receives identification data which identifies the selected files and uses layer service 216 to identify the storage location of the files and prepares them for access by the GIS 218. Based on the identified location, GIS 218 loads the selected files for processing. The GIS 218 subtracts the elevation values for each of the locations defined by the raster grid data in the selected files, as has already been described. The resulting difference topography is then saved as a difference file on shared storage database 219. The difference file may also include data representing the total volume of earth above the design topography, ie, based on a sum or average of all elevation values in the difference file that are more positive than a specified positive tolerance. The total volume of earth needing to be filled, is also calculated based on the average or sum of elevations having a negative value more negative than the specified negative tolerance.

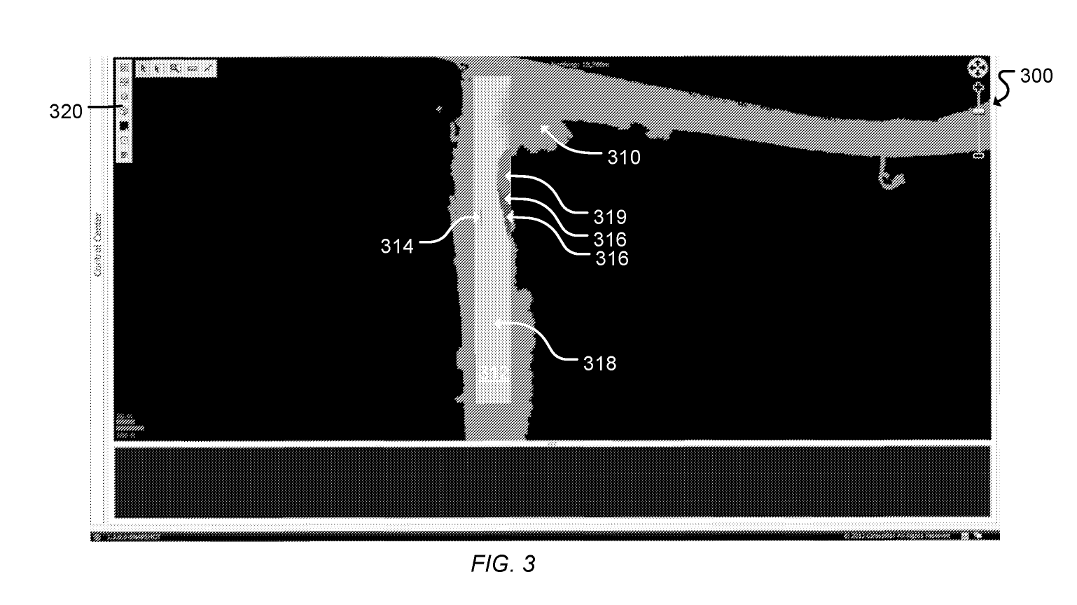

The difference raster and, optionally, one or both of the input rasters being compared in the difference raster, are sent to the web browser on client terminal 220. Initially, the topographic information represented by the rasters are presented on monitor 230 as a 2-dimensional plan, view of the worksite, or the portion(s) of the worksite represented by the rasters. FIG. 3 illustrates a user interface 300 showing the 2-dimensional view. The area of the worksite represented by the recorded elevation map is represented by a first coloured map region 310 (eg. purple) on the user interface. The area of the worksite corresponding to the design topography is represented by a second map region 312, which in FIG. 3 is rectangular. Any portions 314 in the second map region 312 where the height represented in the difference raster is greater than a maximum allowable height above the height of the design is represented as being above grade and illustrated in a second colour (eg. in red). Any portions 316 within the second map region 312 where at which the height of the mine worksite is below a maximum specified height beneath the design height is represented by a third colour (eg. blue) since they are below grade. Any portions 318 within the second map region 312 that the difference file has determined to be between the maximum specified height above the design and the maximum specified height below the design are determined to be “on grade” and are represented by a fourth colour (eg. green). A fifth colour (eg. aqua) is used to illustrate any portions 319 of the design topography area for which no difference information is available (eg. because these regions may not have recorded elevations in the elevation map). The user can configure the application server 212 to enter a 3D mode of visualisation to present the user with a 3D visualisation of the design area by selecting 3D icon 320.

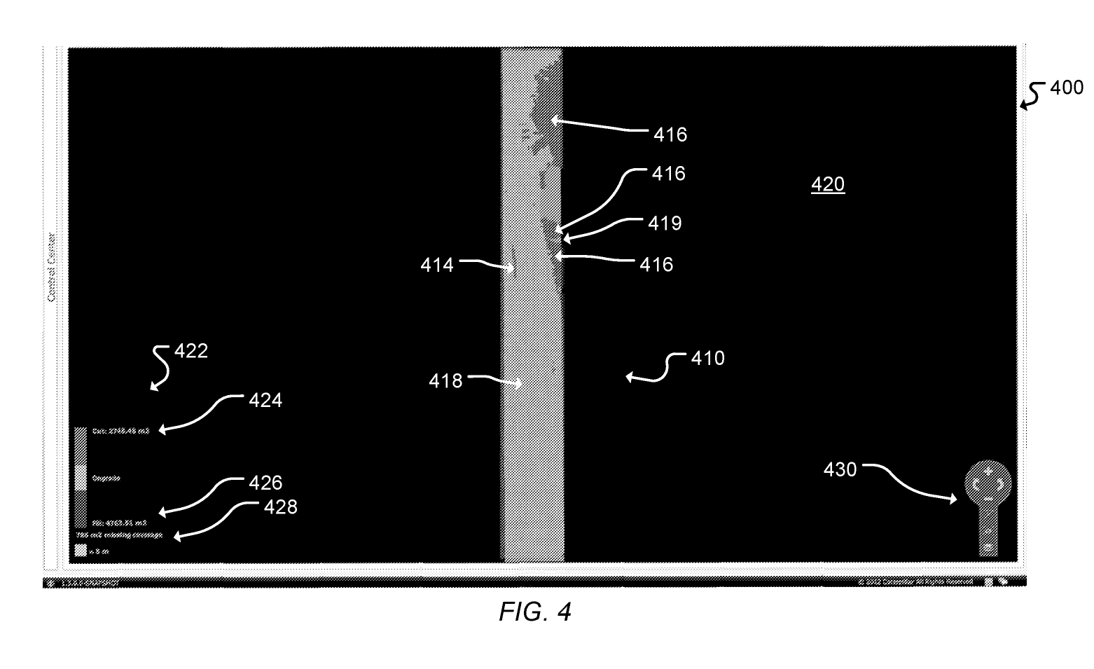

The initial view 400 in 3D mode is illustrated in FIG. 4. View 400 shows the area of interest 410 which corresponds to the area associated with the designed topography. The area of interest 410 is displayed on a background 420, which is generally black but may be a different nominated colour. This initial view 400 is still a 2-dimensional, plan view of the area of interest but may be manipulated by the user to present a 3-dimensional projection of the determined 3D model of the area of interest 410. The 3D mode uses the same colouring scheme as described in relation to the 2D mode in FIG. 3. Therefore, portion 414 illustrated in red denotes a region at which the worksite's elevation is above grade, blue portions 416 illustrate areas of the worksite that have elevations below grade, and green portions 418 illustrates areas of the worksite that are on grade. The 3-dimensional shapes of the intended design and the actual worksite surface are not visible in this view because the projected perspective is in plan, and therefore appears flat. The intended design for the worksite is nonetheless represented in the displayed image in a distinguishing colour (eg. aqua). However, in FIG. 4, the aqua colour is only visible where elevation data is missing from the elevation map of the worksite, as shown at 419. Also presented in this display is a colour key 422 to illustrate which colours correspond to above grade, on grade and below grade portions. The above grade portions represent the areas of land that needs to be cut from the worksite for the worksite to be on grade, according to the design specifications. The total volume of above grade land is determined from the difference raster and is represented as the cut volume 424. Similarly, the volume beneath the design, between the design and the worksite surface, represents the volume of land needing to be filled to build the worksite surface up to the specified grade level. This volume is represented as fill volume 426, and is similarly determined from the difference raster. The total area for which elevation data is missing is represented by missing coverage area 428. A navigation icon 430 enables the user to rotate the view away from plan view to present a 3D view of the 3D model.

The 3D model is presented to the client terminal 220 in the form of rasterised difference data from the difference file. Also presented are any elevation map or design topography rasters that may be needed to for illustration in the user-requested 3D model. The presence of the elevation map or design topography rasters in the 3D model is optional depending on the requested visualisation. Generally, at least the reference topography (eg. design topography) will be provided with the difference raster. In this way, the divergence in elevations associated with difference raster can be viewed within the context of the design topography. However, optionally, the displayed 3D model may be based solely of the difference raster, so that the displayed 3D model illustrates divergence with respect to a normalised or flattened representation of the design surface topography.

To enable 3D rendering of the 3D model, the application server also sends index buffers and vertex buffers to the client to define how to interpret the raster information in three dimensions and, accordingly, how to render the 3D image to present a 3D visualisation in accordance with the client's visualisation request.

Initially, the client CPU 226 converts the height map information, defined by the provided rasters, into a collection of triangles defined by vertices and edges that collectively form a polygon mesh. Plug-in software on the web browser provides a library to interpret vertex buffers, index buffers and shader programs sent from the application server to define how to render the 3D object to create a 3D visualisation of the image. The 3D model includes metadata for each vertex to indicate what each vertex represents, so that the shaders can render the image accordingly.

For each type of shader, the CPU 226 sends corresponding vertex buffers and index buffers to the GPU 228 to generate data defining the brightness and colour of each pixel so as to format the monitor 230 to display the appropriate 3D visualisation.

### INDUSTRIAL APPLICATION

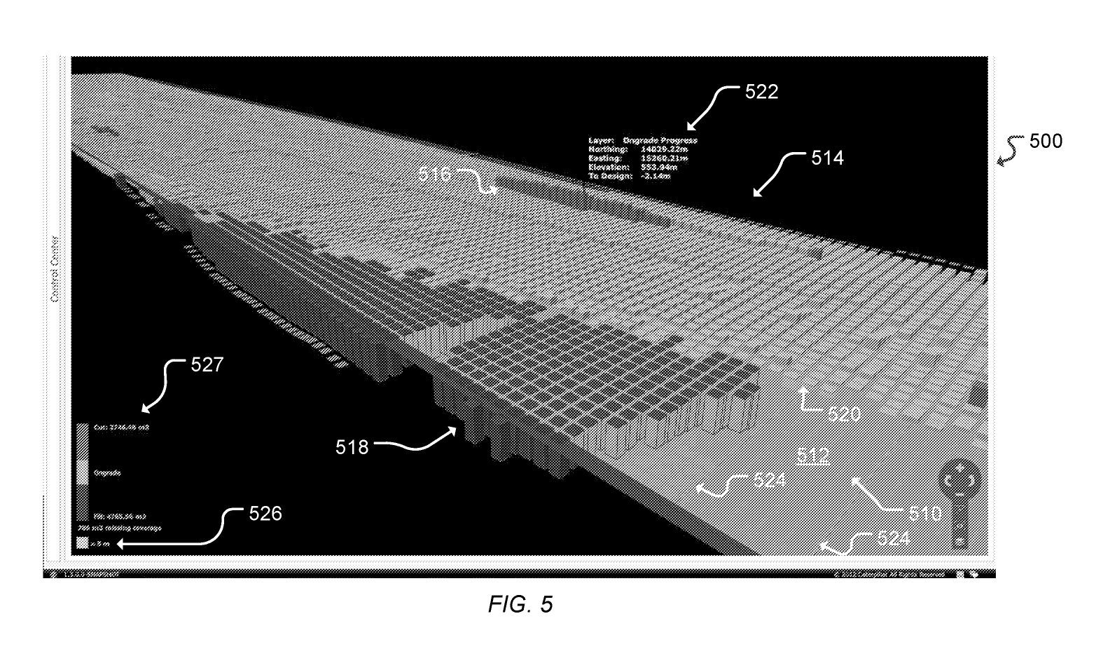

FIG. 5 illustrates an exemplary embodiment of a 3D visualisation of the 3D model that was illustrated in a 2D plan view in FIG. 4. As can be more clearly visualised in FIG. 5, the model is based on rasterised data for the designed elevation topography 512 superimposed with raster data calculated by the GIS that represents the differences in elevation between the designed elevation topography and the elevation map of the worksite. The rendered image 500 of the 3D projection illustrates the divergence between the measured elevation map and the reference (designed) elevation topography by illustrating block-shaped bars that extend from designed surface 512. Upwardly extending bars 514 represent positions in the worksite at which the worksite elevation is greater than the designed elevation. The length (i.e. height) of these bars is indicative of the magnitude of the determined difference in elevation. However the height of the bars is also factored according to the perspective of the 3D projection (i.e. bars further away from the projected viewing position being shorter than bars closer to the viewing position). Bars that represent differences greater than a specified positive deviation from the design elevation are coloured red as indicated at 516 so as to show that these divisions are above grade. Similarly, bars below the design surface which correspond to differences in elevation that diverge from the design elevation by more than a negative deviation limit are indicated in blue as shown at 518. Bars having a magnitude between these positive and negative elevation deviation limits are indicated by green bars 520. Geographic information corresponding to each of the bars can be viewed by placing a cursor over the bar. A geographic information summary 522 displays for that bar, whether the mine site elevation is above grade (requiring cutting), on grade, or below grade (requiring filling). The geographic information summary 522 also displays the associated location coordinates and elevation of the worksite with respect to a positional frame of reference associated with the worksite. The summary 522 also displays the required change in elevation (eg. by cutting or filling the worksite) that is required to bring the worksite elevation within the specified deviation to be considered on grade.

Since the difference elevation superimposed on the reference elevation equals the actual elevation of the worksite, the image 500 in effect displays both the reference topography and the recorded elevation map simultaneously and superimposed on one another. The illustration of reference topography 512 includes spaced line markers to indicate the scale of the displayed model. The distance between adjacent line markers is indicated at 526 in key 527. To enable both positive and negative deviations to be viewed simultaneously despite presence of the reference surface, the reference surface 512 is presented as a semi-transparent surface.

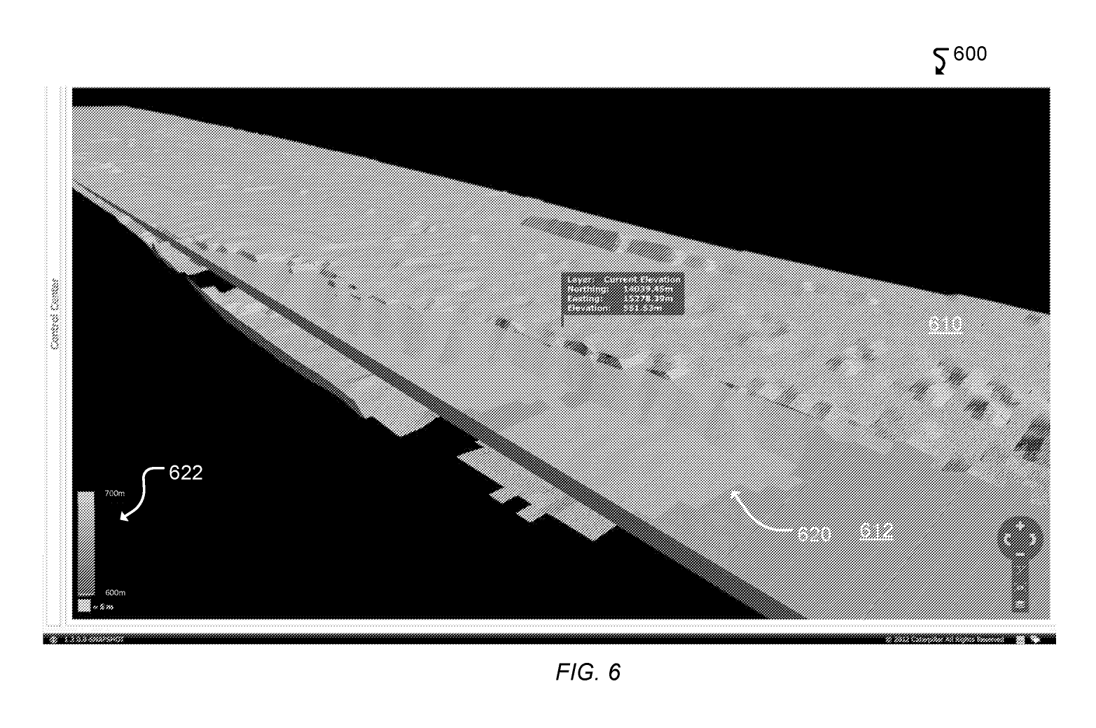

FIG. 6 illustrates an alternative 3-dimensional visualisation of the divergence between the elevation topography of the mine worksite and the reference, design topography. Image 600 similarly displays the elevation map of the mine worksite 610 superimposed on the reference topography 612. In contrast with FIG. 5, however, the elevation map 610 is illustrated by applying a different set of vertex buffers, index buffers and shaders to the raster data sent to the client terminal 220. This set of vertex and index buffers and shaders render the image of the 3D model to portray a surface view of the worksite with rough textured and continuous rendering, rather than the series of discretely spaced vertical bars illustrated in FIG. 5. As can be seen at 620, regions of the worksite surface 610 beneath the reference topography 612 are visible through the semi-transparent visualisation of the reference topography 612. The image 600 also includes a graded colouring of the displayed image in accordance with key 622 so as to indicate the elevation with respect to a reference elevation, such as sea level. Thus, the gradient of the displayed topography can be seen by an associated change in colouring to 3-D model.

The 3D visualisation of the divergence between the reference surface and the measured elevation map enables as user to gain an appreciation for the distribution of earth material with respect to the designed topography, enabling a user to determine the present status of work. By illustrating the work required to completion, a user may determine how to efficiently move earth material eg. from which region to which region, and to ascertain whether enough earth material is available to be cut and moved from on or above grade areas to fill the areas below grade. In FIG. 5, the portrayal of divergence for areas identified as being on grade (green bars 520) enables a user to ascertain whether material, and how much material may be cut, or added to an on grade location without pushing the elevation at that location outside the specified limits of divergence required to maintain on grade elevation.

In other embodiments, rather than comparing the current elevation topography of the mine worksite with a reference design, the current topography may be compared with a topography recorded for a previous time. In this manner, the difference information illustrates how much and where work has been done to progress the mine towards the desired topography, from the topography at a previous time recording to the present time recording.

It will be understood that the invention disclosed and defined in this specification extends to all alternative combinations of two or more of the individual features mentioned or evident from the text or drawings. All of these different combinations constitute various alternative aspects of the invention.

1. A computer-implemented method for illustrating work status for an area of interest of a mine worksite, wherein the method comprises:
determining a dataset comprising:
recorded data representing an elevation map of a surface of the mine worksite for at least the area of interest, the elevation map being based on measured data for the surface; and
reference data representing a reference elevation topography for at least the area of interest; and
generating model data, based on the determined dataset, defining a 3-dimensional model for illustrating, in an image portraying a 3-dimensional view of the model, divergence between the elevation map and the reference elevation topography.

2. The method according to claim 1, wherein the reference elevation topography is a designed elevation topography that is intended for at least the area of interest.

3. The method according to claim 1, wherein the divergence represents differences in elevation between the elevation map and the reference elevation topography at respective positions in the area of interest.

4. The method according to claim 3, wherein differences in elevation are represented in the image as a bars, each bar having a length that is indicative of a magnitude of the difference in elevation, wherein the bars are represented as projections from a display surface, wherein bars corresponding to positive differences in elevation project from a first side of the display surface and bars corresponding to negative differences in elevation project from an opposite side of the display surface.

5. The method according to claim 4, wherein the bars are colour coded to indicate the divergence as being one of:
within a specified range;
a divergence in a positive direction above the specified range; or
a divergence in a negative direction below the specified range,
wherein the specified range is defined as being between a positive deviation limit and negative deviation limit with respect to the reference elevation map.

6. The method according to claim 1, wherein the method includes determining a total volume of worksite that is above grade and a total volume of worksite material that is below grade, with respect to the elevation map, and displaying said volumes in said image.

7. The method according to claim 1, wherein the image displays both the elevation map and the reference elevation topography.

8. The method according to claim 7, wherein in the image, the elevation map appears as opaque and the reference elevation topography appears as translucent.

9. The method according to claim 1, wherein the illustrated divergence includes a representation of differences in elevation between the elevation map and the reference elevation topography at respective positions in the area of interest that are between a positive deviation limit and negative deviation limit with respect to the reference elevation map.

10. A computing system for illustrating work status for an area of interest of a mine worksite, wherein the computing system comprising:
a memory system for storing computer executable instructions;
a processing system configured to read the computer executable instructions from the memory system, wherein upon executing the computer executable instructions, the processing system is configured to:
determine a dataset comprising:
recorded data representing an elevation map of a surface of the mine worksite for at least the area of interest, the elevation map being based on measured data for the surface; and
reference data representing a reference elevation topography for at least the area of interest; and
generate model data, based on the determined dataset, defining a 3-dimensional model for illustrating, in an image portraying a 3-dimensional view of the model, divergence between the elevation map and the reference elevation topography.
